(19) United States
(12) Patent Application Publication
(10) Pub. No.: US 2014/0273784 A1
(43) Pub. Date: Sep. 18, 2014

(54) AIR EXTRACTOR TO REDUCE CLOSING EFFORT

(71) Applicant: FORD GLOBAL TECHNOLOGIES, LLC, Dearborn, MI (US)

(72) Inventors: David Arthur Wade, Plymouth, MI (US); Paul Repp, Plymouth, MI (US); James Antime Marleau, Canton, MI (US)

(73) Assignee: FORD GLOBAL TECHNOLOGIES, LLC, Dearborn, MI (US)

(21) Appl. No.: 13/798,908

(22) Filed: Mar. 13, 2013

(51) Int. Cl. B60H 1/24

(52) U.S. Cl. CPC B60H 1/248
USPC 454/70; 454/162

(57) ABSTRACT

An air extractor optimized for reducing closing efforts when closing a vehicle door is provided. The air extractor includes one or more openings that allow air flow between the passenger compartment of the vehicle and the vehicle exterior. The air extractor also includes a closure member that is movable between an open and closed position, wherein the open position allows air flow through the one or more openings and the closed position inhibits air flow through the one or more openings. The air extractor further includes an actuator that moves the closure member to the open position when one or more vehicle doors are opened and subsequently moves the closure member to the closed position once all doors have been closed.

### FIELD OF THE INVENTION

The present invention generally relates to a vehicle air extractor and more specifically to a vehicle air extractor dedicated to reducing the closing effort when closing a vehicle door.

### BACKGROUND OF THE INVENTION

Improvements in vehicle body sealing have now led to passenger compartments that are highly resilient to air flow between the passenger compartment and vehicle exterior when all doors and windows are closed. One consequence of this is that any introduction of air into the passenger compartment may lead to air pressure build up inside the passenger compartment. For instance, the routine opening of a vehicle door causes air to enter the passenger compartment and increase the air pressure therein. As a result, a higher closing effort is required to close the door, which may negatively impact the perceived quality of the vehicle. Therefore, there is a need for an air extractor that is optimized for exhausting air from the passenger compartment during a vehicle door-closing event in order to reduce closing effort.

### SUMMARY OF THE INVENTION

According to one aspect of the present invention, a vehicle air extractor is provided that includes: an opening formed in a vehicle body; a closure member operably coupled to the opening and movable to an open position to allow air flow through the opening and a closed position to inhibit air flow through the opening; and an actuator operably coupled to the closure member to move the closure member between the open and closed positions.

According to another aspect of the present invention, a vehicle air extractor is provided that includes: a grating that allows air flow between a vehicle passenger compartment and the vehicle exterior; a closure member operably coupled to the grating and movable between an open position to allow air flow through the grating and a closed position to inhibit air flow through the grating; and an actuator operably coupled to the closure member to move the closure member between the open and closed positions.

According to another aspect of the present invention, a vehicle air extractor is provided for reducing the closing effort associated with a vehicle door, and includes: an opening formed between a passenger compartment of the vehicle and the vehicle exterior; and a closure member operably coupled to the opening and movable to an open position that allows air flow through the opening and a closed position that inhibits air flow through the opening.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of a representative automotive vehicle incorporating an air extractor in a door according to one embodiment;

FIG. 2 is a perspective view of one embodiment of an air extractor that includes a grating and a closure member in a slidable engagement;

FIG. 3 is a perspective view of a closure member usable with the air extractor shown in FIG. 2;

FIG. 4 is a partial cross-sectional view of the air extractor corresponding to line IV-IV of FIG. 2, wherein the closure member is shown in an open position;

FIG. 5 is a partial cross-sectional view of the air extractor corresponding to line IV-IV of FIG. 2, wherein the closure member is shown in a closed position;

FIG. 6 is a perspective view of one embodiment of the air extractor that includes a curved grating capable of being formed in a curved structure of a vehicle body; and

FIG. 7 is perspective view of one embodiment of the air extractor that includes a circular grating and closure member in a pivotal engagement.

### DETAILED DESCRIPTION OF THE PREFERRED EMBODIMENTS

As required, detailed embodiments of the present invention are disclosed herein. However, it is to be understood that the disclosed embodiments are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Referring to FIG. 1, an automotive vehicle 2 is generally shown and includes any conventional vehicle type used today such as a coupe, sedan, sports utility vehicle, truck, and/or crossover vehicle. The vehicle 2 includes a body 4 that defines a passenger compartment 6. The body 4 typically includes multiple doors 8 that may be opened and closed as occupants enter and/or exit the vehicle 2. When one or more doors 8 are opened, air from the exterior of the vehicle 2 may enter the passenger compartment 6 and build up pressure therein. Thus, during door-closing events, air pressure in the passenger compartment 6 typically results in higher closing efforts, a generally undesirable vehicle characteristic that may lead to occupants slamming the doors 8 with greater force, thereby causing higher pressure pulse waves throughout the vehicle 2.

To relieve the air pressure in the passenger compartment 6, an air extractor 10, also known as a closing effort exhauster (CEE), is exemplarily provided on the side panel of the door 8 to allow air to exhaust out of the passenger compartment 6 so less closing effort is required for an occupant to close the door 8. In doing so, the occupant may be less likely to slam the door 8, which also results in lessened pressure pulse waves created by the door-closing event. As should be appreciated by those skilled in the art, the vehicle 2 may be outfitted with more than one air extractor 10 and those skilled in the art should recognize the existence of a variety of other suitable air extractor 10 locations such as the rear of the vehicle 2, behind light fixtures, the wheel wells, and/or the undercarriage of the vehicle 2.

Referring to FIGS. 2-7, multiple embodiments of the air extractor 10 are shown, wherein each embodiment includes one or more openings 12 that form a grating 14 in a body structure 15 of the vehicle 2. The body structure 15 may include the body 4 of the vehicle and/or fixtures mounted thereto. When unobstructed, the grating 14 allows air to flow between the passenger compartment 6 and the vehicle exterior. Also included, is a closure member 16 that is operably coupled to the grating 14 and movable between an open position and a closed position relative to the grating 14 to form a pressure relief valve (PRV) that controls air egress through the grating 14. In the open position, the closure member 16 allows air to pass through the grating 14, whereas in the closed position, the closure member 16 inhibits air from passing through the grating 14. The closure member 16 may be constructed from a rigid or resilient material and may further include sound proofing solutions such as conventional sound deadening foams, coatings, and/or sound shields.

To effectuate movement of the closure member 16, an actuator 18 is operably coupled to the closure member 16 and configured to move the closure member 16 to the open position when one or more doors 8 are opened so that air from the passenger compartment 6 can be exhausted through the grating 14 to the exterior of the vehicle 2. The closure member 16 remains in the open position until all doors 8 have been closed, at which point the actuator 18 moves the closure member 16 to the closed position to inhibit air from being further exhausted from the passenger compartment 6 and to also reduce noise ingress from the exterior of the vehicle 2. The actuator 18 may be controlled by a control mechanism (not shown) that senses whether each door 8 is in a closed or open state. For example, the actuator 18 may be driven by the same signal from preexisting systems such as a vehicle drop glass module. In addition, the actuator 18 may also be driven by the HVAC fan relay to assist the HVAC with a variety of operations such as defrosting of windows.

With specific reference to FIGS. 2-5, one general embodiment of the air extractor 10 is shown, wherein the closure member 16 is slidably engaged with the grating 14. In this embodiment, the grating 14 is planar and formed from a first plurality of openings 12a that extend vertically relative to a first base 20 of the grating 14. The first plurality of openings 12a are evenly spaced and dispersed throughout a first non-open region 22a of the grating 14. The closure member 16 is also planar and comprises a second plurality of openings 12b that extend vertically relative to a second base 24 of the closure member 16. The second plurality of openings 12b are also evenly spaced and dispersed throughout a second non-open region 22b of the closure member 16.

In operation, the actuator 18, which may be a solenoid or a motor, slides the closure member 16 horizontally relative to the base of the grating 14 between the open and closed positions. As shown in FIG. 2a, the first and second plurality of openings 12a, 12b are aligned in the open position. The closed position is shown in FIG. 2b, wherein the first plurality of openings 12a of the grating 14 are covered by the second non-open region 22b of the closure member 16 and the second plurality of openings 12b of the closure member 16 are covered by the first non-open region 22a of the grating 14. Regarding the present embodiment, it should be noted that the spacing between the second plurality of openings 12b is slightly smaller than the spacing between the first plurality of openings 12a to ensure that each of the plurality of openings 12a, 12b are adequately covered when the closure member 16 is in the closed position.

While the grating 14 and closure member 16 have been shown and described in a planar configuration having a first and second plurality of openings 12a, 12b, that extend vertically, those skilled in the art will recognize that a variety of grating configurations can be conceived that are operable with a closing member that slides. For example, as shown in FIG. 6, the grating 14 and closure member 16 may be curved and the first and second plurality of openings 12a, 12b may extend horizontally instead. In that embodiment, the greater surface area of the grating 14 and closure member 16 provides increased efficiency in exhausting air from the passenger compartment 6 and also allows the air extractor 10 to be formed in curved structures. Also in contrast with the previous embodiment, the actuator 18 may now slide the closure member 16 vertically relative to the second base 24 of the closure member 16.

With particular reference to FIG. 7, an alternate embodiment of the air extractor 10 is shown wherein the closure member 16 is pivotally engaged with the grating 14. In this embodiment, the grating 14 and the closure member 16 are circular and concentrically aligned, wherein the first and second plurality of openings 12a, 12b have a conical shape and extend radially relative to a central region 26 of the grating 14 and the closure member 16. The actuator 18, which can be a step motor, pivots the closure member 16 about a pivot axis 28 that is transverse to the central region 26 such that the second plurality of openings 12b is rotated about the pivot axis 28 to align with the first plurality of openings 12a in the open position and be covered in the closed position. As previously noted, the spacing between the second plurality of openings 12b is slightly smaller than the spacing between the first plurality of openings 12a to ensure that each of the plurality of openings 12a, 12b are adequately covered when the closure member 16 is in the closed position.

Those skilled in the art will also recognize that a variety of grating configurations can be conceived that are operable with a closure member 16 that pivots. For example, the grating 14 and the closure member 16 may be semi-spherical to provide greater surface area and it follows that the first and second plurality of openings 12a, 12b may take on other desired shapes as well.

Accordingly, an air extractor 10 has been advantageously described herein. The air extractor 10 benefits from being powered and may be employed in a variety of configurations to provide reduction of closing effort during a door-closing event as well as unwanted sound entry.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A vehicle air extractor, comprising:
an opening formed in a vehicle body;
a closure member operably coupled to the opening and movable to an open position to allow air flow through the opening and a closed position to inhibit air flow through the opening; and
an actuator operably coupled to the closure member to move the closure member between the open and closed positions.

2. The vehicle air extractor of claim 1, wherein the actuator is operably coupled to a control mechanism associated with the opening and closing of a vehicle door, wherein the control mechanism causes the actuator to move the closure member to the open position when at least one vehicle door is opened and move the closure member to the closed position when all of the vehicle doors have been closed.

3. The vehicle air extractor of claim 1, wherein the actuator slides the closure member between the open and closed positions.

4. The vehicle air extractor of claim 3, wherein the opening comprises a first plurality of openings that form a grating and the closure member comprises a second plurality of openings, wherein the second plurality of openings are aligned with the first plurality of openings of the first grating when the closure member is in the open position.

5. The vehicle air extractor of claim 4, wherein the first plurality of openings extend in one of a transverse and lateral direction relative to a base of the first grating.

6. The vehicle air extractor of claim 1, wherein the actuator pivots the closure member between the open and closed positions.

7. The vehicle air extractor of claim 5, wherein the opening comprises a first plurality of openings that form a grating and the closure member comprises a second plurality of openings, wherein the second plurality of openings are aligned with the first plurality of openings of the first grating when the closure member is in the open position.

8. The vehicle air extractor of claim 7, wherein the first plurality of openings extend radially from a substantially central region of the first grating.

9. A vehicle air extractor, comprising:
a grating that allows air flow between a vehicle passenger compartment and the vehicle exterior;
a closure member operably coupled to the grating and movable between an open position to allow air flow through the grating and a closed position to inhibit air flow through the grating; and
an actuator operably coupled to the closure member to move the closure member between the open and closed positions.

10. The vehicle air extractor of claim 9, wherein the grating comprises one of a planar and curved surface.

11. The vehicle air extractor of claim 9, wherein the actuator is operably coupled to a control mechanism associated with the opening and closing of a vehicle door, wherein the control mechanism causes the actuator to move the closure member to the open position when at least one vehicle door is opened and move the closure member to the closed position when all of the vehicle doors have been closed.

12. The vehicle air extractor of claim 9, wherein the actuator slides the closure member between the open and closed positions.

13. The vehicle air extractor of claim 12, wherein the grating comprises one of a plurality of openings extending transversely relative to a base of the grating and a plurality of openings extending laterally relative to a base of the grating.

14. The vehicle air extractor of claim 9, wherein the actuator pivots the closure member between the open and closed positions.

15. The vehicle air extractor of claim 14, wherein the grating comprises a plurality of openings extending radially relative to a substantially central area of the grating.

16. A vehicle air extractor for reducing the closing effort associated with a vehicle door, comprising:
an opening formed between a passenger compartment of the vehicle and the vehicle exterior; and
a closure member operably coupled to the opening and movable to an open position that allows air flow through the opening and a closed position that inhibits air flow through the opening.

17. The vehicle air extractor of claim 16, further comprising an actuator that is configured to move the closure member between the open and closed positions.

18. The vehicle air extractor of claim 17, further comprising a control mechanism associated with the opening and closing of the vehicle door, wherein the control mechanism causes the actuator to move the closure member to the open position when at least one vehicle door is opened and move the closure member to the closed position when all of the vehicle doors have been closed.

19. The vehicle air extractor of claim 16, wherein the opening comprises a plurality of openings that form a grating in a body structure of the vehicle.

20. The vehicle air extractor of claim 16, wherein the closure member is operably coupled to the opening in one of a slidable engagement and pivotal engagement.
